(19) United States
(12) Patent Application Publication
(10) Pub. No.: US 2008/0178133 A1
(43) Pub. Date: Jul. 24, 2008

(54) Method and Apparatus for Implementing Enhanced Timing Performance Through Bus Signal Wire Permutation With Repowering Buffers

(76) Inventors: Jente Benedict Kuang, Austin, TX (US); Chun-Tao Li, Rochester, MN (US); Salvatore Nicholas Storino, Rochester, MN (US)

Correspondence Address: IBM CORPORATION;ROCHESTER IP LAW DEPT 917, 3605 HIGHWAY 52 N, ROCHESTER, MN, 55901-7829, US

(21) Appl. No.: 11/626,417

(22) Filed: Jan. 24, 2007

(51) Int. Cl. G06F 17/50

(52) U.S. Cl. 716/6

(57) ABSTRACT

A method and apparatus implement improved timing performance of a signal bus through wire permutation with repowering buffers. A repowering buffer includes a prebuffer and a postbuffer. A plurality of prebuffers and postbuffers are stored in a design library, each having a set wiring ordered arrangement for selectively providing wire permutation of the signal bus. A wiring order of prebuffer at the beginning of the bus is identical to the wiring order of the postbuffer at the end of bus. The wiring order of the postbuffer driving the beginning of bus wires between adjacent repowering buffers is identical to the wiring order of the prebuffer receiving at the end of the bus wires. A wiring order of the downstream buffer pairs is chosen so that there is at least one pair of wires separated by another wire or wires in the bus.

### FIELD OF THE INVENTION

The present invention relates generally to the semiconductor devices, and more particularly, relates to a method and apparatus for implementing improved timing performance of a signal bus through wire permutation with repowering buffers.

### DESCRIPTION OF THE RELATED ART

The performance of a signal bus, and the entire chip, often is often limited by the worst-case timing performance of a signal. The timing performance of a signal in a bus is very much related to the timing behavior of the neighboring signals. The Miller effect among the interconnects is a well-known problem for signal repowering designs. The theorem states:

i=c(dv/dt),

Which means that the current that is injected into the victim signal wires is proportional to the voltage differential between the aggressor and the victim, and the coupling capacitance in between.

The use of the repowering buffers that are often needed to meet the performance constraint as chip designs are scaled down may actually amplify the problem. The conventional thinking is that insertion of the repowering buffers will help with the signal waveform in that slew will be improved. In fact, usage of the repowering buffer may amplify the timing problem due to the Miller effect.

Referring to FIG. 1 the timing problem due to the Miller effect may be understood. Assume there are two signal wires, such as wires A and B, which are having opposite signal transitions that are indicated by lines labeled R for rising signal transition, and F for falling signal transition.

According to Miller's theorem, the dv/dt between A and B will be maximum and the signal degradation of wires A and B will be at their worst. As a result, slews on A and B will increase and slacks will decrease. The reductions of slack will accumulate along the bus since this transition occurs at each repowering stage labeled REPOWER BUFFER. As a result, the performance penalty due to signal fighting on A and B is proportional to the number of repowering stages on this bus.

Most of the known solutions for this problem are aimed at the reduction of the coupling capacitance, for example, to increase the wire spacing, usage of low-K insulation material between the wires, and the like. Other proposed arrangements include repositioning of repowering buffers or staggered repowering and encoding and decoding of the signals on the bus to avoid the signal fighting; however, such arrangements require availability of specific chip area and efforts for calculated buffer placement and the performance overhead for the signal encoding and decoding is large.

A need exists for a mechanism for implementing repowering buffer designs for implementing improved timing performance of a signal bus through wire permutation.

### SUMMARY OF THE INVENTION

Principal aspects of the present invention are to provide a method and apparatus for implementing improved timing performance of a signal bus through wire permutation with repowering buffers. Other important aspects of the present invention are to provide such method and apparatus for implementing improved timing performance of a signal bus through wire permutation with repowering buffers substantially without negative effect and that overcome many of the disadvantages of prior art arrangements.

In brief, a method and apparatus are provided for implementing improved timing performance of a signal bus through wire permutation with repowering buffers. A repowering buffer includes a prebuffer and a postbuffer. The prebuffer includes a plurality of inverters, each having an input connected to a predefined bus wiring track. The postbuffer includes a plurality of inverters, each having an output connected to a predefined bus wiring track. A plurality of prebuffers and postbuffers are stored in a design library, each having a set wiring ordered arrangement for selectively providing wire permutation of the signal bus. A wiring order of prebuffer at the beginning of the bus is identical to the wiring order of the postbuffer at the end of bus. The wiring order of the postbuffer driving the beginning of bus wires between adjacent repowering buffers is identical to the wiring order of the prebuffer receiving at the end of the bus wires.

In accordance with features of the invention, a wiring order of a downstream buffer pair of a postbuffer and a prebuffer is chosen so that there is at least one pair of wires separated by another wire or wires in the bus.

In accordance with features of the invention, a method enables reduction of the dv/dt between signal wires using wire permutation with repowering buffers including an algorithm for selecting a sequence of wire permutation patterns to maximize Miller capacitance reduction with minimized overhead including wire crossing and a number of required books.

In accordance with features of the invention, the algorithm defines a permutation pattern width, PW, as the number of signals within a bus to be used for the wire permutation. The algorithm requires the PW to be 2ⁿ where n is greater than 1, for example, PW=4, 8, 16, and the like.

In accordance with features of the invention, a wiring order of each sequential downstream buffer pair is selected from the design library for the selected sequence of wire permutation patterns.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 illustrates a conventional signal bus repowering buffer arrangement;

FIGS. 2A and 2B illustrate an exemplary apparatus for implementing improved timing performance of a signal bus through wire permutation with repowering buffers in accordance with the preferred embodiment;

FIG. 3A illustrates a conventional signal bus repowering buffer configuration;

FIGS. 3B, 3C, and 3D illustrate exemplary configurations for implementing improved timing performance of a signal bus through wire permutation with repowering buffers in accordance with the preferred embodiments;

FIG. 4A illustrates results of the conventional signal bus repowering buffer configuration of FIG. 3A;

FIGS. 4B, 4C, and 4D illustrate exemplary results of the exemplary configurations of FIGS. 3B, 3C, and 3D for implementing improved timing performance of a signal bus through wire permutation with repowering buffers in accordance with the preferred embodiments;

FIGS. 5A and 5B are block diagram representations illustrating a computer system and operating system for implementing wire permutation with repowering buffers in accordance with the preferred embodiment;

FIG. 6 is a flow chart illustrating exemplary steps for implementing wire permutation with repowering buffers in accordance with the preferred embodiment; and

FIG. 7 is a block diagram illustrating a computer program product in accordance with the preferred embodiment.

### DETAILED DESCRIPTION OF THE PREFERRED EMBODIMENTS

In accordance with features of the preferred embodiments, a method enables reduction of the dv/dt between signal wires using wire permutation with repowering buffers. Permutation of relative track position of the signal wires to each other is provided between each repowering stage. This enables distributing and amortizing the performance penalty due to the signal fighting and increasing overall slack and timing performance of the signal bus.

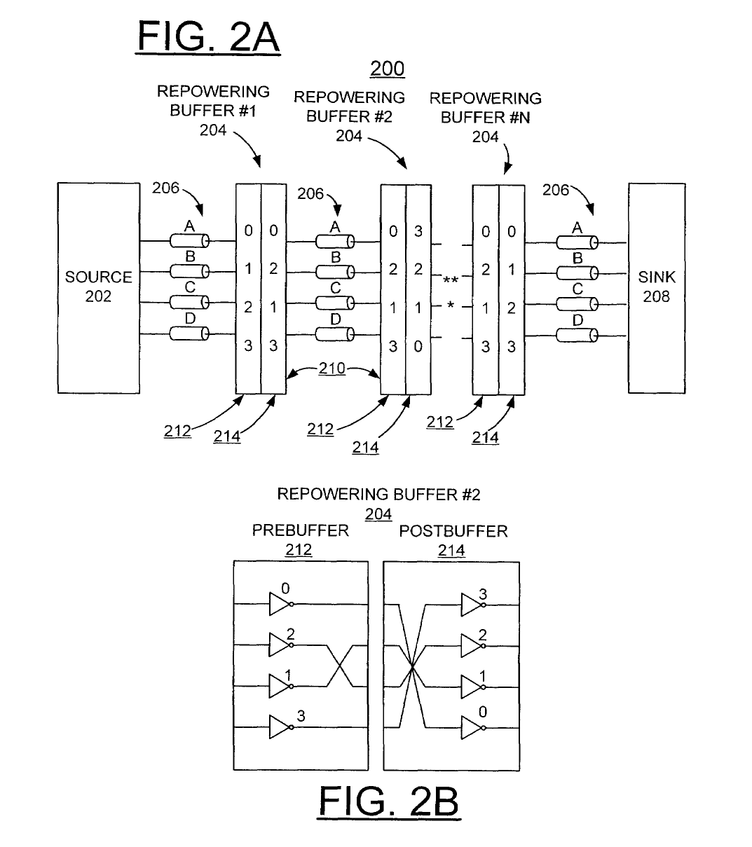

Having reference now to the drawings, in FIGS. 2A and 2B there is shown an exemplary apparatus for implementing improved timing performance of a signal bus through wire permutation with repowering buffers generally designated by the reference character 200 in accordance with the preferred embodiment. Repowering buffer apparatus 200 includes a source 202 coupled by a plurality of repowering buffers #1-N, 204 together with respective interconnecting bus wires A, B, C, D, 206 to a sink 208.

Each of the repowering buffers #1-N, 204 includes a prebuffer 212 and a postbuffer 214. The repowering buffers 204 providing respective inverter pairs into the prebuffer 212 and postbuffer 214, for example as shown in FIG. 2B.

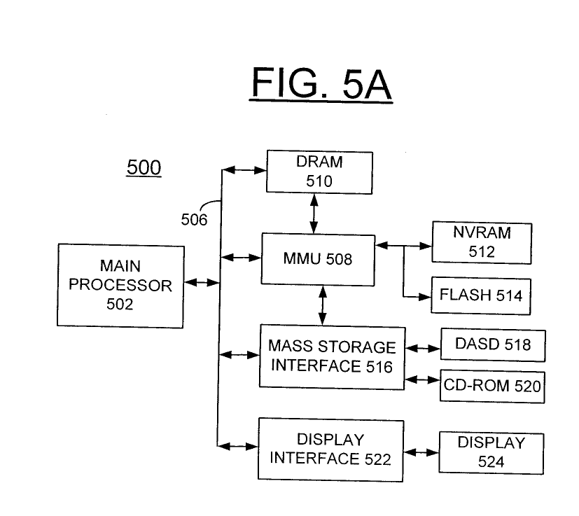

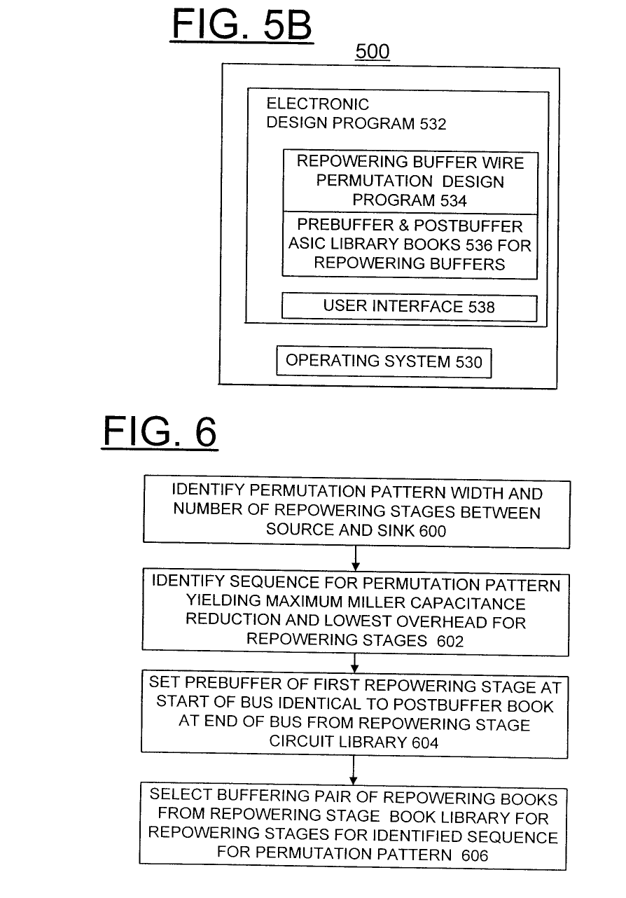

In accordance with features of the preferred embodiments, the permutation of wiring tracks A, B, C, D, 206 is done within the respective prebuffers 212 and postbuffers 214. This approach optimizes the usage of layout resources and minimizes the performance overhead caused by the wire permutation. Like the existing buffer books, there are a set of prebuffer and postbuffer books 536 that are developed and stored as part of the standard cell library as illustrated and described with respect to FIGS. 5A and 5b. This minimizes the design effort for custom circuit designers and EDA routing and placement programs. The only added constraints when using this set of prebuffer and postbuffer books 536 of the preferred embodiments include the following:

In accordance with features of the preferred embodiments, the wiring order of prebuffer book 212 at the beginning of the bus must be the identical to the wiring order of the postbuffer book at the end of bus, for example, “0123” prebuffer 212 is used to accept the signals from the driver or source 202, and “0123” postbuffer 214 shall be used for driving the repowered signal to the sink 208.

In accordance with features of the preferred embodiments, the wiring order of the postbuffer book 214 driving the beginning of the wires 206 must be identical to the wiring order of the prebuffer book 212 receiving at the end of the wires, for example, “0213” postbuffer 214 of repowering buffer #1, 204 driving wires 206 connecting “0213” prebuffer 212 of repowering buffer #2, This postbuffer 214 and prebuffer 212 at the beginning and the end of the wire 206 define a “buffering pair.”

In accordance with features of the preferred embodiments, the downstream buffer pair is arranged so that there is a pair of wires, or multiple pair of wires depending on the width of the repowering books, separated by other wires in the bus. For example, for example, referring to postbuffer 214 and prebuffer 212 of repowering buffers #1 and #2, 204, with the illustrated wiring order “0123”->“0213,” track 0 and 1 are now separated and isolated by track 2.

In accordance with features of the preferred embodiments, a method enables reduction of the dv/dt between signal wires using wire permutation with repowering buffers with an algorithm for selecting a sequence of wire permutation patterns to maximize Miller capacitance reduction with minimized overhead, such as wire crossing, number of required books, and the like.

In accordance with features of the invention, the repowering buffer wire permutation effectively reduces the Miller capacitance and improves the overall timing performance of the signal bus. The selection of wire permutation pattern at each stage of the bus is provided to enhance efficiency of this technique. A novel algorithm is provided to select the proper sequence of wire permutation patterns which yields maximum Miller capacitance reduction with lowest overhead, for example, wire crossing, number of required books, and the like. The selection of a wire permutation pattern at each stage of the bus is critical to the efficiency of the method of the preferred embodiments. An exemplary novel algorithm of the preferred embodiments is illustrated and described with respect to the flow chart of FIG. 6.

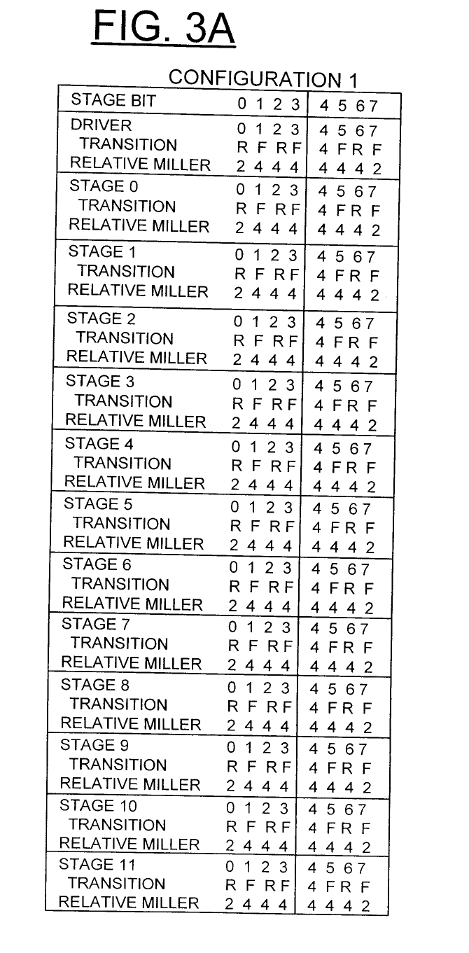

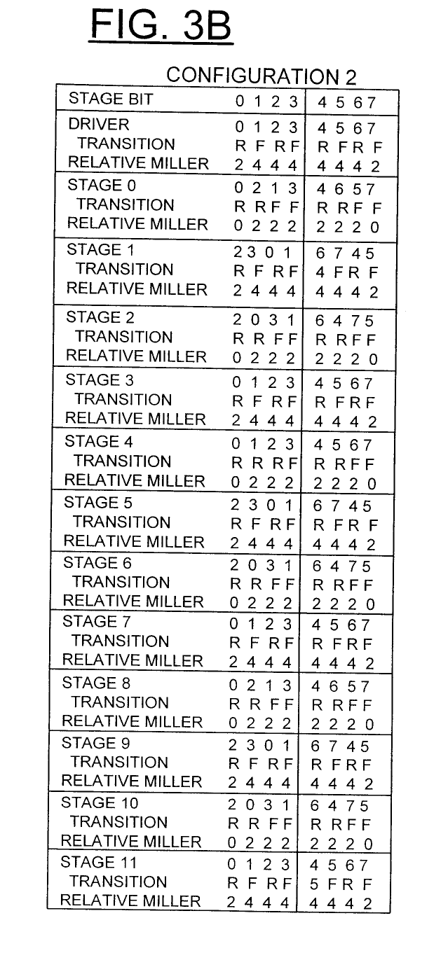

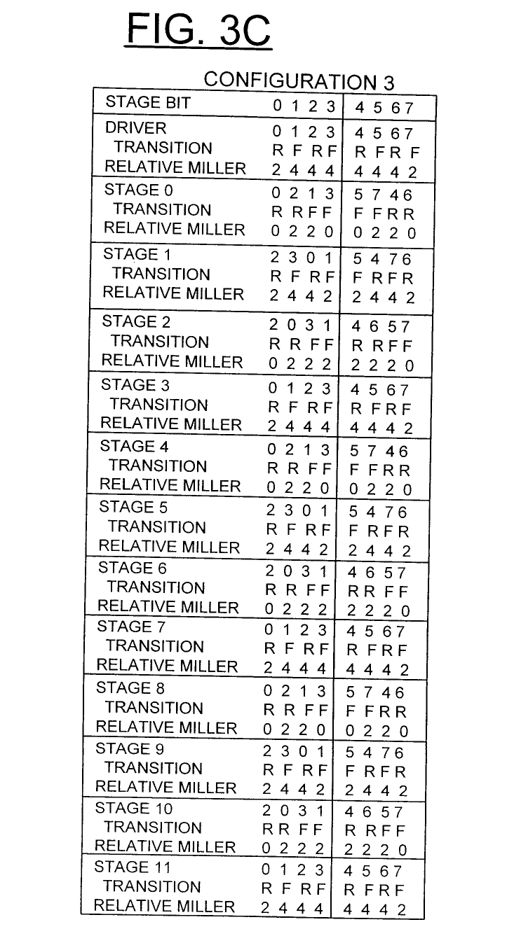

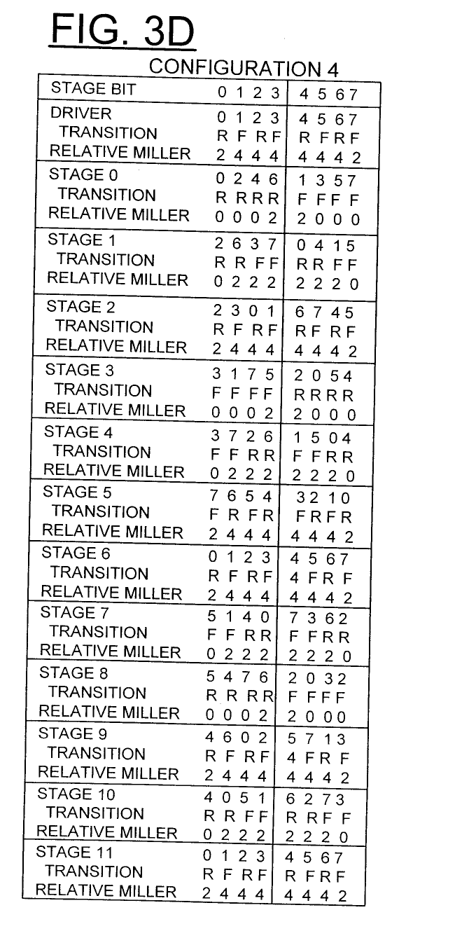

Referring now to FIG. 3A and FIGS. 3B, 3C, and 3D, exemplary repowering stages are illustrated. In FIG. 3A there is shown a conventional signal bus repowering buffer configuration. FIGS. 3B, 3C, and 3D illustrate exemplary configurations for implementing improved timing performance of a signal bus through wire permutation with repowering buffers in accordance with the preferred embodiments. Twelve (12) repowering stages 0-11 are illustrated between a driver and a sink and a three-row box indicates each stage. The first row indicates which signal is at a bus track position. The second row indicates the signal transition at that stage, where R indicates rising and F indicates falling. The third row approximates the Miller effect seen by the signal caused by the wire or wires in the neighboring track or tracks. The number indicates the multiplier to the Miller capacitance, for example, “2” means the Miller capacitance at that segment will be two times of what the wire will see if there is only one neutral neighbor. Ideally, this Miller capacitance number is as low as possible because Miller capacitance is directly related to the time constant of signal propagation.

As shown in FIG. 3A with the conventional signal bus repowering buffer configuration 1, no wire permutation is provided. FIGS. 3B, 3C, and 3D illustrate exemplary configurations 2, 3, and 4 in accordance with the preferred embodiments.

As shown in FIG. 3B, Configuration 2 is an implementation of the algorithm with PW=4 and there are two wire permutation groups as indicated by two separate boxes. The permutation pattern width, PW, is defined as the number of signal within a bus to be used for the wire permutation.

As shown in FIG. 3C, Configuration 3 is an implementation of the modified version of the algorithm with PW=4 and there are two wire permutation groups as indicated by two separate boxes. The illustrated modified version has the Step 3's even and odd group assignment reversed for one of the two wire permutation groups, such that the even repowering stage reserves the first half of the available track position for the odd group and the odd repowering stage reserves the first half of the available track position for the even group.

As shown in FIG. 3D, Configuration 4 is an implementation of the algorithm with PW=8.

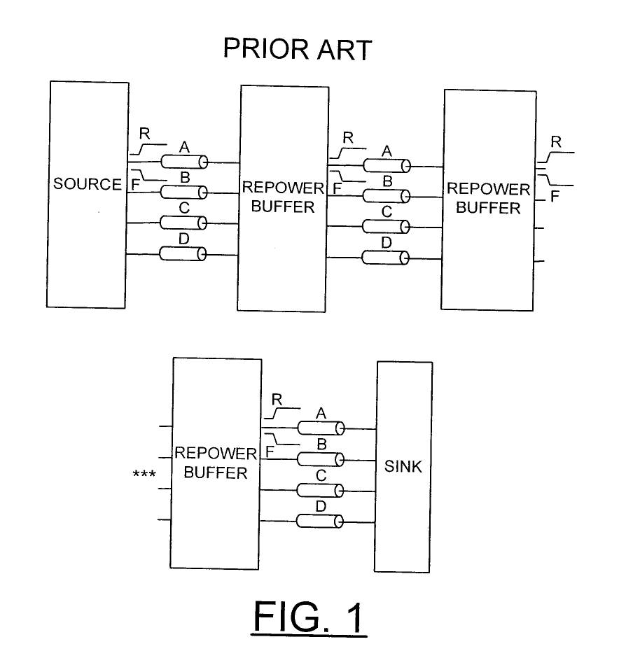

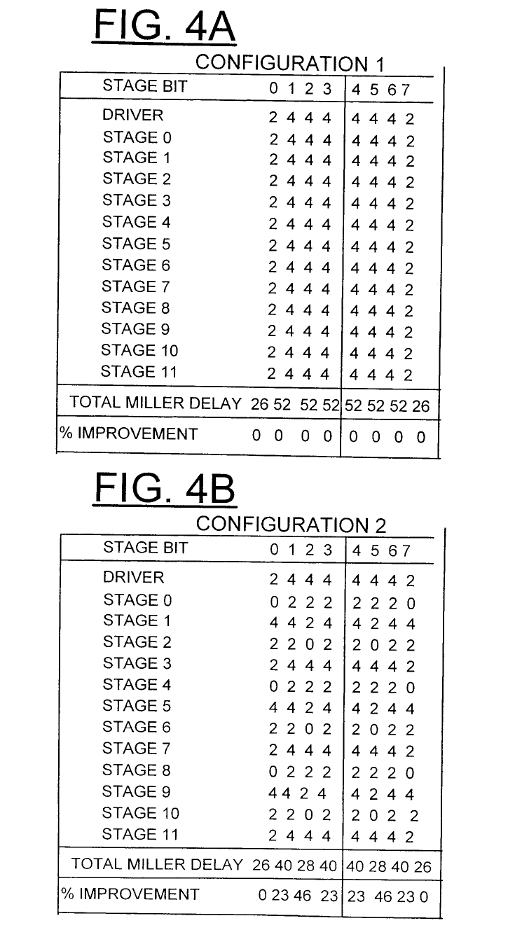

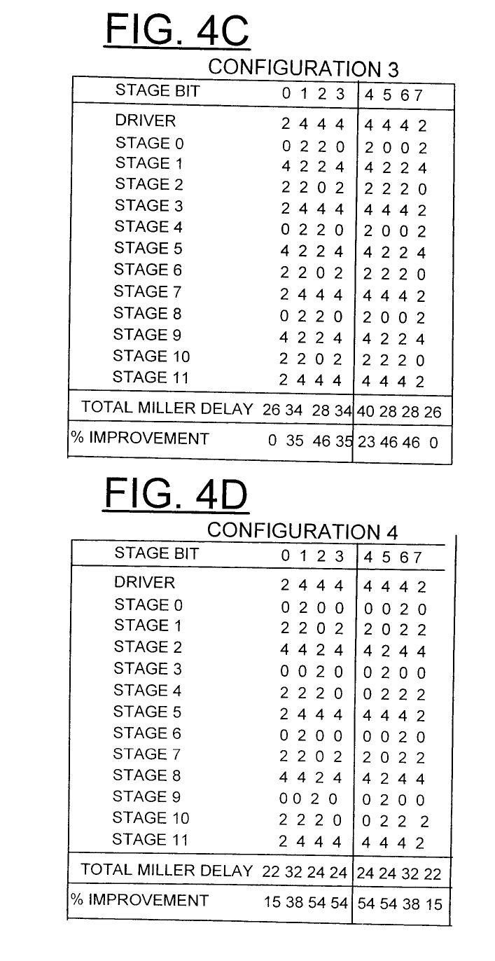

FIG. 4A illustrates results of the conventional signal bus repowering buffer configuration of FIG. 3A. FIGS. 4B, 4C, and 4D illustrate exemplary results of the exemplary configurations of FIGS. 3B, 3C, and 3D for implementing improved timing performance of a signal bus through wire permutation with repowering buffers in accordance with the preferred embodiments. All the Miller multipliers along the path for each signal in each configuration are summed. The result is used to compare and contrast the relative timing performance of each configuration. The “% of improvement” field provides an estimate to quantify the performance improvement offered by wire permutation in Configuration 2, 3, and 4 of FIGS. 3B, 3C, and 3D against the non-wire-permutated result in the conventional Configuration 1 of FIG. 1.

As shown by FIG. 4D, configuration 4 provides the best improvement of the three wire permutation setups. The improvement is especially significant when comparing to the conventional non-wire-permutated setup as indicated FIGS. 3A and 4A. For some signals, a novel algorithm of the invention offers, for example, up to 54% improvement.

Referring now to FIGS. 5A and 5B, there is shown a computer system generally designated by the reference character 500 for implementing timing performance of a signal bus through wire permutation with repowering buffer design in accordance with the preferred embodiment. Computer system 500 includes a main processor 502 or central processor unit (CPU) 502 coupled by a system bus 506 to a memory management unit (MMU) 508 and system memory including a dynamic random access memory (DRAM) 510, a nonvolatile random access memory (NVRAM) 512, and a flash memory 514. A mass storage interface 516 coupled to the system bus 506 and MMU 508 connects a direct access storage device (DASD) 518 and a CD-ROM drive 520 to the main processor 502. Computer system 500 includes a display interface 522 coupled to the system bus 506 and connected to a display Computer system 500 is shown in simplified form sufficient for understanding the present invention. The illustrated computer system 500 is not intended to imply architectural or functional limitations. The present invention can be used with various hardware implementations and systems and various other internal hardware devices, for example, multiple main processors.

As shown in FIG. 5B, computer system 500 includes an operating system 530, an electronic design program 532, a repowering buffer wire permutation design program 534 of the preferred embodiment, a plurality of stored prebuffer and postbuffer Application Specific Integrated Circuit (ASIC) library books 536 for repowering buffers 204 in accordance with the preferred embodiment, and a user interface 538.

Referring now to FIG. 6, there are shown exemplary steps for implementing enhanced bus timing performance with repowering buffer wire permutation designs in accordance with the preferred embodiment.

As indicated at a block 600, a permutation pattern width, PW, defined as the number of signal within a bus to be used for the wire permutation and a number of repowering stages between a source and sink are identified. The novel algorithm of the invention requires the PW to be 2ⁿ and n is greater than 1, for example, PW=4, 8, 16, and the like. Please note that PW does not need to match the width of the bus. This is due to the fact that the delay overhead incurred by internal wire crossing from one track to the other track may be larger than the performance gained by providing the wire permutation. This is especially true for wide buses, for example, for a bus width greater than or equal to 128. This algorithm guarantees that the worst case wire crossing is PW/2, for example if the bus is 8-bit wide, then the wire crossing overhead for doing the wire permutation is 8/2=4 bit wide. The maximum PW for a specific CMOS technology family depends upon a physical library setup, including for example, bit image width, device characterization, including for example, device strength, such as MOSFET's strength for pull-up and pull down, wire properties, including for example, resistivity and dielectric constant, and the like. A critical path analysis is performed to determine the maximum PW.

As indicated at a block 602, a sequence is identified for permutation pattern yielding a maximum miller capacitance reduction and lowest overhead for the repowering stages between the source and sink. For example, after the PW value is determined, the algorithm can proceed with wire permutation pattern for every repowering segment. Starting with the repowering stage, which is next, downstream from the bus signal source to the repowering stage, which is next, upstream from the bus signal receiver. For example, the following exemplary steps are performed for each repowering stage”

Step 1. If the current repowering stage is the last repowering stage of the bus, use a matching or regular wire pattern (i.e., non-permutated) and skip Step 2 and 3. This ensures that the receiver receives the right signal in the proper wiring track. If this is not the last repowering stage of the bus, go to Step 2.

Step 2. Separate the signals from the previous repowering stage into two groups, even and odd, according to the signal's track position at the previous repowering stage. The order of signals' relative track position information within the perspective group is maintained and used in the next step.

Step 3. If the current repowering stage is the even repowering stage of the bus, for example, stage 0, 2, 4, and the like, assign the signals in the even group to the first half of available track positions and then follow by the odd group. If the current repowering stage is the odd repowering stage of the bus, for example, stage 1, 3, 5, and the like, assign the signals in the odd group to the first half of available bit positions in the next repowering segment, followed by the even group.

Step 4. Move onto the next repowering stage and start with Step 1.

As indicated at a block 604, the prebuffer of the first repowering stage at the start of the bus connected to a source must be set identical to the postbuffer at the end of the bus connected to a sink from the repowering stage book circuit library 536. Buffering pair of repowering books are selected from the repowering stage book library 536 for the sequential repowering stages for identified sequence of permutation patterns, as indicated at a block 606.

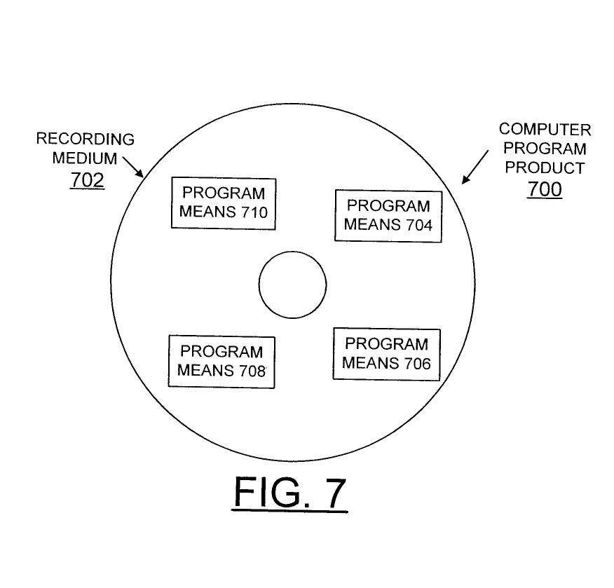

Referring now to FIG. 7, an article of manufacture or a computer program product 700 of the invention is illustrated. The computer program product 700 includes a recording medium 702, such as, a floppy disk, a high capacity read only memory in the form of an optically read compact disk or CD-ROM, a tape, a transmission type media such as a digital or analog communications link, or a similar computer program product. Recording medium 702 stores program means 704, 706, 708, 710 on the medium 702 for carrying out the methods for implementing improved timing performance of a signal bus through wire permutation with repowering buffers of the preferred embodiment in the system 500 of FIGS. 5A and 5B.

A sequence of program instructions or a logical assembly of one or more interrelated modules defined by the recorded program means 704, 706, 708, 710, direct the computer system 500 for implementing wire permutation with repowering buffers of the preferred embodiment.

While the present invention has been described with reference to the details of the embodiments of the invention shown in the drawing, these details are not intended to limit the scope of the invention as claimed in the appended claims.

What is claimed is:

1. A method for implementing improved timing performance of a signal bus through wire permutation with repowering buffers comprising the steps of:
storing a plurality prebuffers and postbuffers, each having a plurality of inverters for respectively connecting to a predefined bus wiring track, each of the stored prebuffers and postbuffers having a set wiring ordered arrangement for selectively providing wire permutation of the signal bus;
providing a selected matching wiring order for a prebuffer at the beginning of the signal bus connected to a source and a postbuffer at the end of bus connected to a sink; said selected matching wiring order matching a driving signal bus order of the source; and
providing an identical selected permutation wiring order of each postbuffer driving a beginning of bus wires between adjacent repowering buffers identical to a selected wiring order of the prebuffer receiving at the end of the bus wires.

2. The method for implementing improved timing performance of a signal bus as recited in claim 1 wherein providing an identical selected permutation wiring order includes selecting a permutation wiring order to provide at least one pair of wires separated by another wire in the signal bus.

3. The method for implementing improved timing performance of a signal bus as recited in claim 1 wherein providing an identical selected permutation wiring order includes selecting a permutation pattern width PW.

4. The method for implementing improved timing performance of a signal bus as recited in claim 3 further includes selecting said permutation pattern width PW equal to 2ⁿ where n is greater than 1.

5. The method for implementing improved timing performance of a signal bus as recited in claim 3 further includes identifying a number of repowering stages between the source and the sink.

6. The method for implementing improved timing performance of a signal bus as recited in claim 5 further includes selecting a sequence of wire permutation patterns for said repowering stages between the source and the sink.

7. The method for implementing improved timing performance of a signal bus as recited in claim 1 wherein providing an identical selected permutation wiring order includes selecting a sequence of wire permutation patterns for repowering stages between the source and the sink.

8. The method for implementing improved timing performance of a signal bus as recited in claim 7 further includes selecting buffering pairs for said identified sequence of wire permutation patterns for repowering stages between the source and the sink.

9. The method for implementing improved timing performance of a signal bus as recited in claim 7 wherein selecting said sequence of wire permutation patterns for repowering stages between the source and the sink includes identifying a sequence of wire permutation patterns for repowering stages between the source and the sink to maximize miller capacitance reduction.

10. The method for implementing improved timing performance of a signal bus as recited in claim 9 further includes identifying said sequence of wire permutation patterns for repowering stages between the source and the sink to maximize miller capacitance reduction and having a lowest overhead.

11. Apparatus for implementing improved timing performance of a signal bus through wire permutation with repowering buffers comprising:
a design library storing a plurality of prebuffers and postbuffers, each having a plurality of inverters for respectively connecting to a predefined bus wiring track, each of the stored prebuffers and postbuffers having a set wiring ordered arrangement for selectively providing wire permutation of the signal bus;
a repowering buffer wire permutation design program providing a selected matching wiring order for a prebuffer at the beginning of the signal bus connected to a source and a postbuffer at the end of bus connected to a sink; said selected matching wiring order matching a driving signal bus order of the source; and
said repowering buffer wire permutation design program providing an identical selected permutation wiring order of each postbuffer driving a beginning of bus wires between adjacent repowering buffers identical to a selected wiring order of the prebuffer receiving at the end of the bus wires.

12. Apparatus for implementing improved timing performance of a signal bus through wire permutation with repowering buffers as recited in claim 11 wherein said repowering buffer wire permutation design program providing an identical selected permutation wiring order of each postbuffer driving a beginning of bus wires between adjacent repowering buffers identical to a selected wiring order of the prebuffer receiving at the end of the bus wires includes said repowering buffer wire permutation design program selecting a permutation wiring order to provide at least one pair of wires separated by another wire in the signal bus.

13. Apparatus for implementing improved timing performance of a signal bus through wire permutation with repowering buffers as recited in claim 11 wherein said repowering buffer wire permutation design program providing an identical selected permutation wiring order of each postbuffer driving a beginning of bus wires between adjacent repowering buffers identical to a selected wiring order of the prebuffer receiving at the end of the bus wires includes said repowering buffer wire permutation design program identifying a sequence of wire permutation patterns for repowering stages between the source and the sink to maximize miller capacitance reduction.

14. Apparatus for implementing improved timing performance of a signal bus through wire permutation with repowering buffers as recited in claim 11 wherein said repowering buffer wire permutation design program providing an identical selected permutation wiring order of each postbuffer driving a beginning of bus wires between adjacent repowering buffers identical to a selected wiring order of the prebuffer receiving at the end of the bus wires includes said repowering buffer wire permutation design program selecting a permutation pattern width PW; and said permutation pattern width PW being equal to 2ⁿ where n is greater than 1.

15. Apparatus for implementing improved timing performance of a signal bus through wire permutation with repowering buffers as recited in claim 14 further includes said repowering buffer wire permutation design program identifying a number of repowering stages between the source and the sink.

16. Apparatus for implementing improved timing performance of a signal bus through wire permutation with repowering buffers as recited in claim 14 further includes said repowering buffer wire permutation design program identifying a sequence of wire permutation patterns for repowering stages between the source and the sink.
